(19) United States
(12) Patent Application Publication
(10) Pub. No.: US 2026/0275758 A1
(43) Pub. Date: Sep. 17, 2026

(54) Rotating Tent

(71) Applicant: Carlee Stull, Tampa, FL (US)

(72) Inventor: Carlee Stull, Tampa, FL (US)

(21) Appl. No.: 19/079,123

(22) Filed: Mar. 13, 2025

(51) Int. Cl. E04H 15/26; E04H 15/60; E04H 15/62; F21S 9/03; F21V 33/00

(52) U.S. Cl. CPC E04H 15/26; E04H 15/60; E04H 15/62; F21S 9/03; F21V 33/006

(57) ABSTRACT

A tent as disclosed includes a center pole comprising an underground screw at a bottom end and a boss proximal a top end and a plurality of collapsible segments there between. The disclosure also includes an attachment ring configured to rest on the boss and rotatingly hold a central point of the tent to the center pole. The disclosure additionally includes a tent canopy comprising the central point sustained by the attachment ring and stretched out by at least three perimeter points defining an open portion between two of the at least three perimeter points. The disclosure yet includes a movable anchor for each of the plurality of perimeter points and configured to maintain a radial distance from the center pole.

### BACKGROUND OF THE INVENTION

Summer camping can be hot inside a tent that is closed for mosquito control. Campers offer air conditioning but are prohibitively expensive for many people who want to get away from home. Trailers, tent trailers and tents are less expensive but do not offer air conditioning. On the other hand, air moving fans offer some relief but simply push air around inside a tent and cannot offer relief in extreme climates.

Portable A/C units and portable heaters offer some relief where there is electricity available but are not very efficient and after market hookups are makeshift and prone to malfunction. The hookup of separately sold units aren't reliable not to mention bulky and heavy and time consuming for interfacing connections.

There is therefore a long felt need in the market for a functional, light-weight and convenient airflow tent system that is also able to transform into a portable and transportable unit with other camping gear and for semi-permanent housing needs in military, government and emergency situations.

### SUMMARY OF THE INVENTION

A tent as disclosed includes a center pole comprising an underground screw at a bottom end and a boss proximal a top end and a plurality of collapsible segments there between. The disclosure also includes an attachment ring configured to rest on the boss and rotatingly hold a central point of the tent to the center pole. The disclosure additionally includes a tent canopy comprising the central point sustained by the attachment ring and stretched out by at least three perimeter points defining an open portion between two of the at least three perimeter points. The disclosure yet includes a movable anchor for each of the plurality of perimeter points and configured to maintain a radial distance from the center pole.

Other aspects and advantages of embodiments of the disclosure will become apparent from the following detailed description, taken in conjunction with the accompanying drawings, illustrated by way of example of the principles of the disclosure herein.

### BRIEF DESCRIPTION OF THE DRAWINGS

FIG. 1 is an outside perspective view of a two panel rotating tent in accordance with an embodiment of the present disclosure.

FIG. 2 is an outside perspective view of a multiple panel rotating tent in accordance with an embodiment of the present disclosure.

Throughout the description, similar and same reference numbers may be used to identify similar and same elements in the several embodiments and drawings. Although specific embodiments of the invention have been illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to a person of ordinary skill in the relevant art and having possession of this disclosure, are to be considered within the scope of the invention.

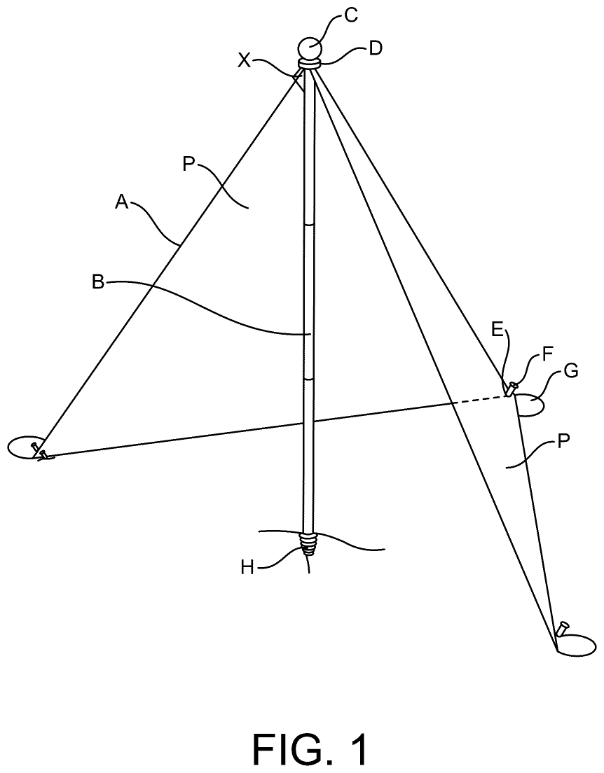

FIG. 1 is an outside perspective view of a two panel rotating tent in accordance with an embodiment of the present disclosure. The view includes the tent canopy A, the collapsible center pole B, the end cap C, the attachment ring D, the grommet E for stakes F, the sand pouches G, the underground screw to secure the tent too the ground H, the two panels P and the retractable boss X. The term ‘rotatingly’ indicates a rotation of the attachment ring around the center pole.

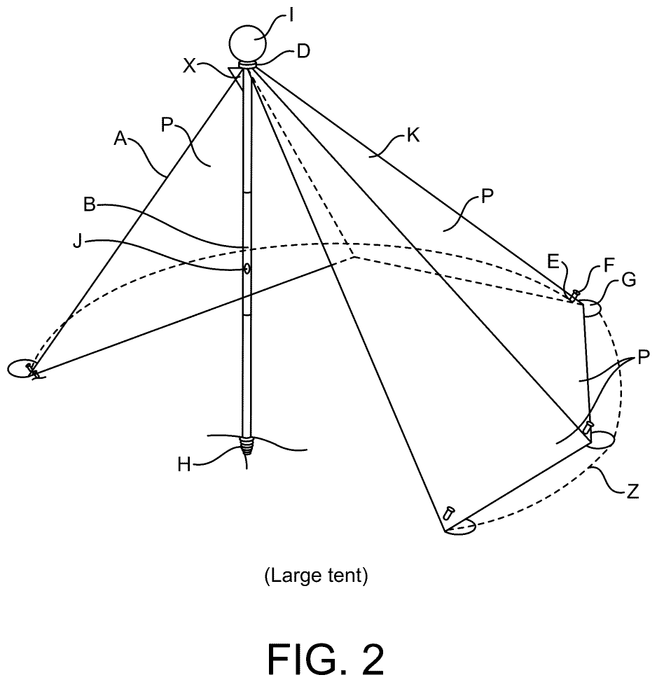

FIG. 2 is an outside perspective view of a multiple panel rotating tent in accordance with an embodiment of the present disclosure. The view includes the tent canopy A, the collapsible center pole B, the end cap C, the attachment ring D, the grommet E for stakes F, the sand pouches G, the underground screw to secure the tent into the ground H, the solar powered black light orb I, the electrical switch J, the multiple panels P and the retractable boss X, and a perimeter hoop Z depicted in broken lines as an option to maintain a radial distance from the center pole.

The boss X retracts into the center pole to allow the tent canopy to collapse around the center pole as the attachment ring slides down the segmented center pole like a collapsible umbrella. Also, the movable anchors are implemented as wheels in embodiments to enable the tent to rotate about the center pole. The electrical switch J completes a circuit from the switch via wires inside the center pole to a solar light or other device at the top end of the center pole.

Therefore, the present disclosure satisfies the long felt need for an economical, secure and convenient tent that is also able to easily transform for packing, moving and hiking with other beach, camping or recreational equipment.

Also known as the Hippie Tent, the disclosure provides a versatile, easy-to-assemble shelter solution for outdoor activities such as beach outings, picnics, camping trips, and events. Outdoor enthusiasts tend to prefer access to reliable protection from harmful UV rays and excessive sunlight exposure, often selecting sun umbrellas and canopies as a go-to resource. These items, however, may be complex to set up and not sturdy enough to manage varying weather conditions resulting in constant readjusting which can be a nuisance, physically challenging, and a distraction when trying to enjoy an event or when just relaxing.

The Hippie Tent offers a modern lightweight and collapsible outdoor shelter possessing a triangle-shaped tapestry that effectively provides UV protection from the sun, shaded privacy, customizable features to add personality, and most importantly is simple to set up and deconstruct, as needed. Made from durable materials, including non-tarnishing metal poles and weather-resistant fabrics, the Hippie Tent is designed to withstand prolonged outdoor exposure ensuring longevity, and reliability in diverse environmental conditions as it employs foundational stakes and sand pouches to maintain its stability.

The disclosure is engineered to support a simple and quick assembly process, this protective covering makes it an accessible option for users of all skill levels, as there is no requirement for specialized tools or equipment. Offering two models: a regular size intended for everyday day use at the beach or park, and a large size intended for camping and/or industrial events which includes a solar-powered black light capable of illuminating gatherings or campsites at night. Additionally, the disclosed Hippie Tent allows users to express their style preferences by easily changing the tapestry, enhancing the aesthetic appeal of their outdoor space thus providing a whimsical nature to the accessory.

Altogether, the Hippie Tent offers a practical, stylish, and innovative solution for outdoor shelter needs, setting itself apart with its blend of customization, ease of use, versatility, sun protection, durability, and portability. As a result, the Hippie Tent is essential in the sporting/novelty industry.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Notwithstanding specific embodiments of the invention have been described and illustrated, the invention is not to be limited to the specific forms or arrangements of parts so described and illustrated. The scope of the invention is to be defined by the claims and their equivalents included herein or by reference to a related application.

What is claimed is:

1. A tent comprising:
a center pole comprising an underground screw at a bottom end and a boss proximal a top end and a plurality of collapsible segments there between; an attachment ring configured to rest on the boss and rotatingly hold a central point of the tent to the center pole; a tent canopy comprising the central point sustained by the attachment ring and stretched out by at least three perimeter points defining an open portion between two of the at least three perimeter points;
a movable anchor for each of the plurality of perimeter points and configured to maintain a radial distance from the center pole.

2. The tent of claim 1, wherein the underground screw anchors the center pole into the ground via a helical action.

3. The tent of claim 1, further comprising a solar powered black light mounted on the top end of the center pole.

4. The tent of claim 1, wherein the tent canopy comprises a print comprises a photoluminescent ink sensitive to ultraviolet black light.

5. The tent of claim 1, wherein the open portion is configured to extend from the two of the at least three points to the attachment ring.

6. The tent of claim 1, wherein the movable anchor is a bag of sand.

7. The tent of claim 1, wherein the movable anchor is a sealed bag of water.

8. The tent of claim 1, wherein the movable anchor is a tent stake.

9. The tent of claim 1, wherein the movable anchor is a weighted wheel.

10. The tent of claim 1, further comprising a weighted hoop configured to maintain the movable anchors the radial distance from the center pole.

11. The tent of claim 1, further comprising a wiring inside the center pole and extending from the top end to a switch in a mid portion of the center pole.

12. The tent of claim 1, further comprising a wiring inside the center pole extending from a solar light on the top end to a switch in the pole.

13. The tent of claim 1, wherein the boss is spring loaded in the center pole and configured to recede into the center pole.

14. The tent of claim 1, wherein a plurality of sections of the tent canopy comprise triangular sections extending from the attachment ring to the at least three perimeter points.

15. The tent of claim 1, wherein the attachment ring is configured to slide over the boss and collapse the tent canopy toward the bottom end like a collapsible umbrella.
